(19) United States
(12) Patent Application Publication
(10) Pub. No.: US 2010/0131429 A1
(43) Pub. Date: May 27, 2010

(54) METHOD FOR RECIPIENTS OF MAIL TO INFORM MAILERS OF MAILING PREFERENCES

(75) Inventors: Richard W. Heiden, Shelton, CT (US); Theresa Biasi, Shelton, CT (US)

Correspondence Address: PITNEY BOWES INC., 35 WATERVIEW DRIVE, MSC 26-22, SHELTON, CT, 06484-3000, US

(73) Assignee: Pitney Bowes Inc., Stamford, CT (US)

(21) Appl. No.: 12/277,757

(22) Filed: Nov. 25, 2008

(51) Int. Cl. G07B 17/02; G06Q 10/00; G06Q 50/00

(52) U.S. Cl. 705/404; 705/410

(57) ABSTRACT

A method and system for identifying recipient mailing preferences to mailers. A mail preparation center sends a plurality of mail recipients mail pieces having a mail campaign identifiers printed thereon. Mail recipients communicate with a data center to input the mail campaign identifiers received. The data center also gathers recipients' future mail campaign mailing preference options. The recipient preferences are communicated back to the mailing center. The mail preparation center may include a postage meter with at least one accounting register for accounting for value and the further steps of processing the plurality of mail pieces with the postage meter to account in the accounting register for the value of the mail piece mail campaign identifier of each mail piece processed by the postage meter.

### FIELD OF THE INVENTION

The invention disclosed herein relates generally to a system and method for processing mail and more particularly, to a system and method for recipients of mail to inform mailers of recipients' mailing preferences.

### BACKGROUND OF THE INVENTION

Recipients of mail often receive mailings that are of no interest to the recipient. These mailings may include magazines, journals, solicitations, catalogs, coupons, announcements about new businesses in the recipient's area and other various mailings. The mailing recipients have either been required to directly contact the mailer to request removal of the recipients name from the mailing list, a time consuming process, or to attempt to utilize a do not mail service. These do not mail services are services which allow a recipient to have their name removed from a mailing list managed by the service or where the service directly contacts the mailer on behalf of the mail recipient. Many of these services involve a recipient going to a website and completing a suitable form to have their name removed from a mailing list for a particular mailing campaign and also enable the mail recipient to request additional or other types of mailing.

The above method of trying to reduce unwanted mail is inefficient. The service may not handle the particular mailing that is of interest to the mail recipient and for which the recipient wishes to have their name removed from the mailing list. Also, the service may not be able to contact the mailer directly on behalf of the mail recipient.

Although it may be in the mailers' interest to remove mail recipients from a mailing list where the recipient is not interested in the particular campaign or related campaigns, the communications between the mailer and recipient is not efficient. The recipient may not be able to easily contact the mailer. The mailer may not understand the wishes of the recipient and the recipient may not understand the various options available to the recipient from the mailer in connection with eliminating mail, receiving additional mail or other options.

It is desirable to facilitate communications whereby unwanted mail is eliminated and desired mail is received with the ability to expand into other areas of mail types that may be of interest to the recipient and mailer. Furthermore it is desirable to provide a system whereby the mailer can manage mailing lists of recipients to maximize the value of the mailings and to save on mailings to recipients who are not appropriate candidates for a particular mailing campaign. This saves in terms of the need to print less campaign materials to be mailed and the associated postage costs.

### SUMMARY OF THE INVENTION

It is an object of the present invention to facilitate communications between mailers and mail recipients regarding options that the mail recipients may have with respect to a given mail campaign.

It is another object of the present invention to enhance the value of mailing campaigns by improving the ability of mailers to more effectively manage mailings to mail recipients.

A method for recipients of mail to inform mailers of mailing preferences embodying the present invention includes the steps of communicating, from a mail preparation center to a data center, mail recipient options with respect to a mail campaign. The mail preparation center sends mail pieces to a plurality of mail recipients included in the mail campaign, each of the mail pieces having a mail campaign identifier printed thereon. At least one of the plurality of mail recipients communicating to the data center a received mail piece mail campaign identifier. The data center communicating to the mail piece recipient the mail campaign mail recipient options. The mail recipient communicating to the data center selected options from the mail campaign mail recipient options communicated to the mail recipient.

A method for recipients of mail to inform mailers of mailing preferences, embodying an aspect of the present invention comprising the steps of communicating from a mail preparation center to a data center a mail campaign mail recipient options with respect to the mail campaign. The mail preparation center sends mail pieces to a plurality of mail recipients included in the mail campaign, each of the mail pieces having a mail campaign identifier printer thereon. At least one of the plurality of mail recipients populating a widget on a mail recipient processing device with a received mail piece mail campaign identifier to communicate to the data center the received mail piece campaign identifier. The data center populates the mail recipient processing device widget with the mail campaign mail recipient campaign options to communicate to the mail piece recipient the mail campaign recipient options. The mail recipient populates the mail recipient processing device widget with mail recipient selected options to communicate to the data center the mail recipient selected options.

In accordance with a feature of the present invention, the mail preparation center includes a postage meter with at least one accounting register for accounting for value and includes the further steps of processing the plurality of mail pieces with the postage meter to account in the accounting register for the value of the mail piece mail campaign identifier of each mail piece processed by the postage meter.

### DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention. As shown throughout the drawings, like reference numerals designate like or corresponding parts.

FIG. 1 is a block diagram of a system for recipients of mail to inform mailers of mailing preferences embodying the present invention;

FIG. 2 is a view of a campaign management request form for recipients of mail to inform mailers of mailing preferences useful in the mailing preferences system shown in FIG. 1;

FIG. 3 is a view of potential recipient preferences form for recipients of mail to inform mailers of mailing preferences useful in the mailing preferences system shown in FIG. 1;

FIG. 4 is a flow chart of the process of how a recipient can set up an account with the data center useful in the mailing preferences system shown in FIG. 1;

FIG. 5 is a flow chart of the process of how a mailer tags mail in a manner useful in the mailing preferences system shown in FIG. 1;

FIG. 6 is a flow chart of the process of how a recipient opts out of a mail campaign in a manner useful in the mailing preferences system shown in FIG. 1; and,

FIG. 7 is a flow chart of the process of how the mailer manages recipient selected options in a manner useful in the mailing preferences system shown in FIG. 1.

### DETAILED DESCRIPTION OF THE PRESENT INVENTION

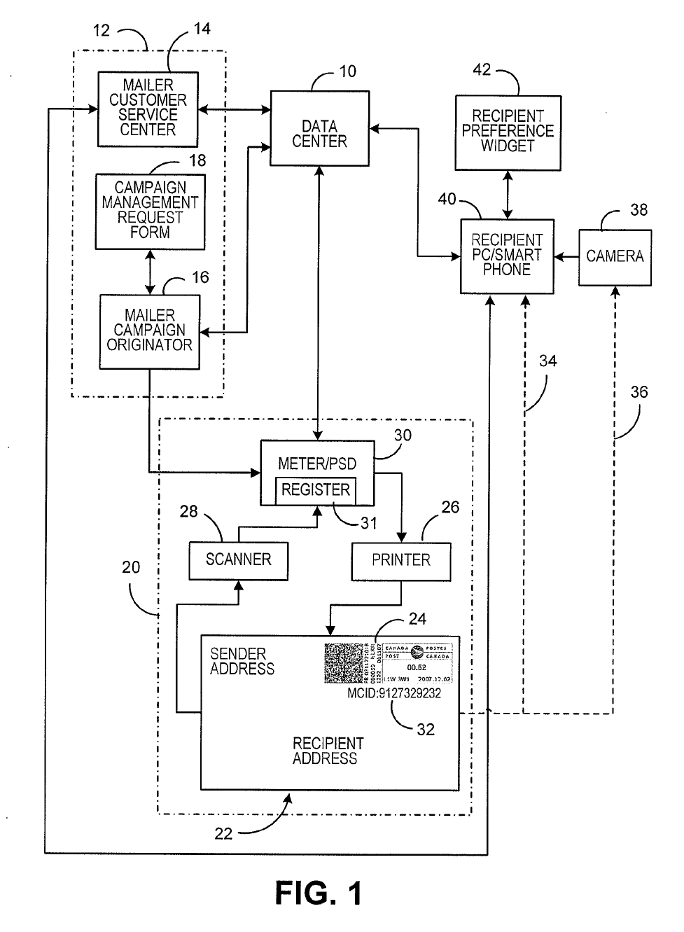

Reference is now made to FIG. 1, a system for recipients of mail to inform mailers of the recipient mailing preferences includes a data center 10 which is the control center for the mailer 12 and may include various operations such as a mailer customer service center 14, a mailing campaign originator 16 which may generate campaign management request forms. The organization of the mailer can vary depending on the particular implementation of the system. However, the mailer customer service center 14 function is in communications with the data center 10 as is the mail campaign originator function 16.

The mailer 12 may prepare and send their mail or have another organization prepare and send the mail to the mail recipients. The mail preparation is shown in block 20. The mail preparation includes the processing of a mail piece such as mail piece 22 which can include the printing of postal indicia 24 on the mail piece. The indicia is printed by a metering system which includes a printer 26 and a scanner 28. Accounting and control of the metering function is performed by the meter/postal security device system (PSD) 30. The meter/PSD 30 accounts for the printing of postage, and can also account for the value of the service provided by the data center such as facilitating communications between the mailer and the recipient. The accounting for value can be in a register 31 in the meter/PSD 30. Meter/PSD systems contain various types of accounting registers which could be employed to implement accounting for the value provided by the data center 10. The scanner scans a mail campaign identifier, such as the campaign identification number 32, when preprinted on the mail piece to provide this information to the meter/PSD 30. Alternatively, the meter/PSD 30 when enabled by the mail campaign originator 16 and/or the data center 10 can cause the meter/PSD 30 printer 26 to print the mail campaign identifier, campaign identification number 32, and also to account for the campaign identifier imprint. The mail campaign identifier can be a numbers, letters or other forms of identification such as symbols or any combination of the foregoing.

As is shown by the dashed lines 34 and 36 the mail piece 22 is delivered to a recipient and may be imaged by recipient PC camera 38 or imaged by a smart phone 40. This can image the mail code identification number and enter it into the mail recipient's PC or into the mail recipient's smart phone, as the case may be, for processing in accordance with available options as provided in the campaign management request form 18. Other suitable processing devices can be employed.

This campaign management request form 18 is communicated by the mail campaign originator to the data center 10. Upon entering information as to the recipients preferences with respect to available options noted in the campaign management request form, the information is communicated through a mail recipient preference widget 42 to the data center 10. Thus, the recipient camera 38 may image the mail piece campaign identifier 32 or the mail piece campaign identifier 32 may otherwise be entered into the system via the smart phone or keyed in by the mail recipient into the PC or the smart phone. The recipient preference widget 42 can be a small utility program in the tool bar of the recipient PC which can be implemented to pop up and contains pre-indicated preferences of the user as well as the PC user identification.

When the mail campaign identification number 32 is entered into the appropriate device, it causes the recipient preference widget 42 populated with the mail campaign identifier to go the data center 10 to become populated with the available options from the campaign management request form and communicated back with that populated information to the mail recipient's PC/Smart phone 40. As a result, the recipient can act on selecting available options.

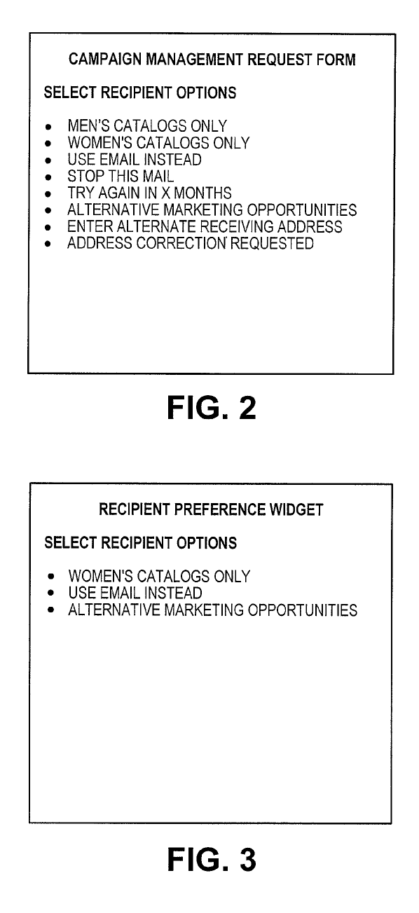

In FIG. 2 the campaign management request form has a series of recipient options for the particular mailing campaign such as a catalog type, or a brochure and the like options. In the particular campaign management request form in FIG. 2 the options include the following: men's catalog only; women's catalog only; use email instead; stop this mail; try again in x months; alternative marketing opportunities; enter alternative receiving address; and, address correction requested. These options populate into the widget 42 and, as can be seen in FIG. 3 for the particular campaign, the mail recipient can select only the following options: woman's catalog only; use email instead; and, alternative marketing opportunities. The widget prompts the recipient to select the particular desired options which were originally communicated by the mailer to the data center 10. The widget 42 with the selected options then communicates the recipient's selected options to the data center 10 for subsequent action. The particular widget form and organization can vary and is designed to meet the mailer's needs for the mailing campaign involving the mail recipient. The form can be tailored to the specific characteristics of each recipient. For example, the options for female mail recipient may be different from the options for male mail recipients or the options may be different based on household income of the mail recipient.

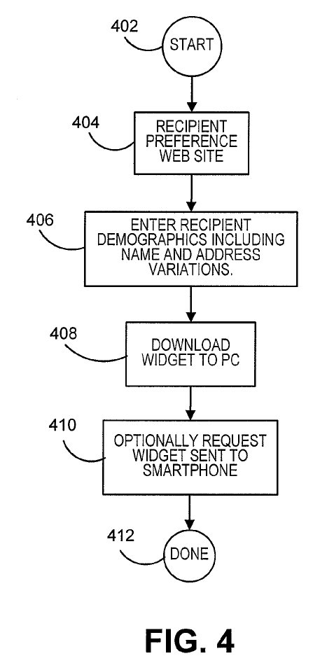

Reference is now made to FIG. 4 which is a flow chart of how a recipient can set up an account with the data center. The process starts at 402. At block 404 the recipient goes to the data center recipient preference web site and at block 406 the recipient demographics are entered including data such as name, address, and other relevant information concerning the recipient such as home telephone number and the like. The data center then downloads at block 408 a widget onto the recipient PC which is used in a manner previously noted. The recipient at block 410 can optionally request that the widget be sent to a smart phone such that the smart phone can control the process. The process is completed at 412.

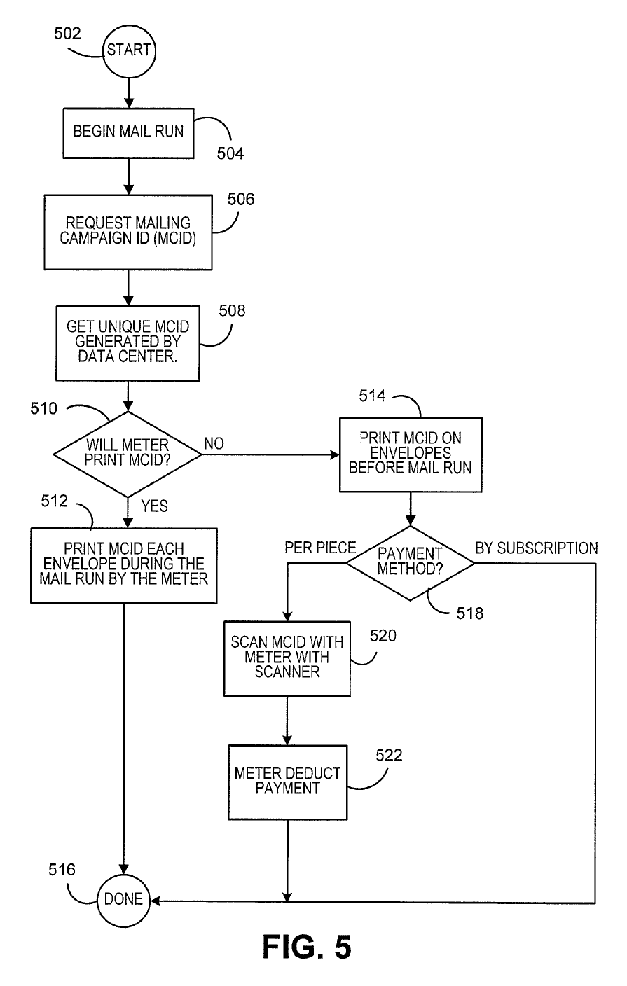

Reference is now made to FIG. 5 which is a flow chart of how a mailer tags mail in a manner for use in the system shown in FIG. 1. The process begins at 502. At block 504 a mail run is begun and at block 506 a mailing campaign identification is requested from the data center 10. At block 508 a unique mailing campaign identification number is obtained from the data center via the communications channel. A determination is then made at decision block 510 whether the mailing campaign identification number will be printed by the meter. If this is the case, at block 512 as the meter run is processed by the meter/PSD 30 the meter printer 26 prints the mail campaign identification number on each mail piece. The meter/PSD 30 may also account for value in the meter/PSD register 31 for the service provided for the mail campaign if this is desired. Where at decision block 510 it is determined that the meter will not print the mail campaign identification number, the mail campaign identification number is printed at block 514 on envelopes before the mail run is commenced. Where the mail campaign identification code is printed at block 512, the process is completed at 516. However, where the mail identification code is printed on the envelopes before the mail run through the meter, the determination is made at decision block 518 as to the method of payment. Where the method of payment is on a per piece basis the mail campaign identification number is scanned at block 520 by the scanner 28. The meter/PSD 30 counts and/or accounts for the particular mail piece scanned. Where meter/PSD accounting is employed, the meter/PSD 30 at block 522 deducts payment for the mail campaign identification service from the meter/PSD 30 funding registers and the process is completed at 516. Where at decision block 518 a determination is made that the payment method is by subscription, the process is completed at 516.

Many payment methodologies that can be used as payment for the services such as payment per mail piece charge with or without per mail piece payment by meter register deduction, payment by subscription and payment per widget feedback/response. In such case the feedback/response is a charge for each time a mail recipient receives and responds, provides a feedback, to the mailer concerning mail recipient preferences.

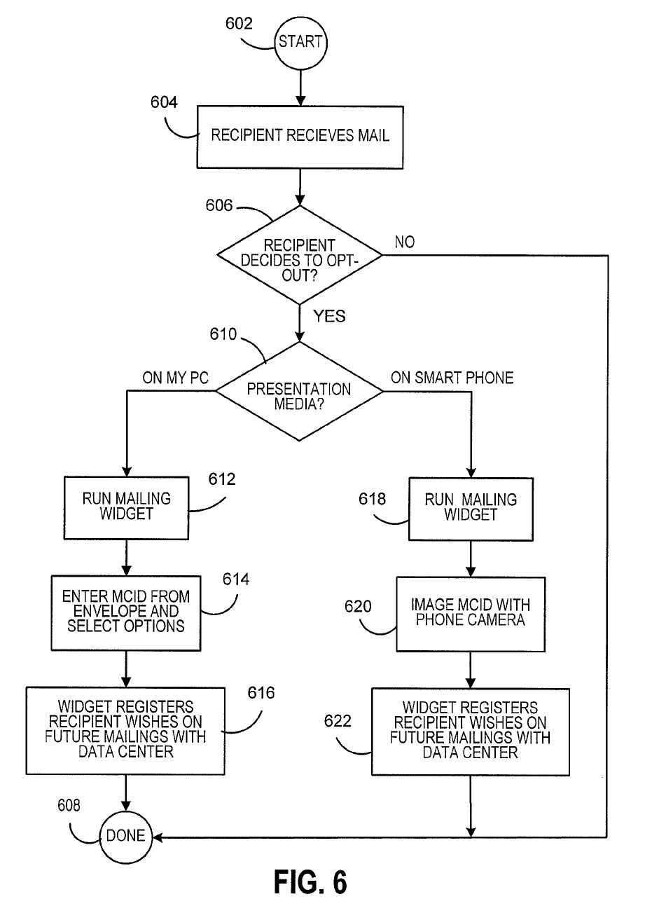

Reference is now made to FIG. 6 which is a flow chart of how a recipient opts out of mail campaign in a manner for use with the system. Other forms of recipient preferences elections can be made in a similar manner. The process starts at 602. At block 604 a recipient receives mail and a determination is made at decision block 606 whether the recipient decides to opt out of the mailing campaign. Various types of recipient options can be implemented and this is an example of how one such request might be processed. If a determination is made at decision block 606 not to opt out, the process is completed at 608. On the other hand, should a determination be made to opt out at decision block 606, at decision block 610 a further determination is made of the media presentation, that is, whether the presentation will be on the recipient's PC or on the recipient's smart phone as previously described in connection with FIG. 1. It should be noted that the mail campaign and preference selection may include future mailings and similar campaigns depending on the processes implemented.

Where the presentation is on the recipient's PC at 612 the recipient runs the mailing widget on the recipient's computer. At 614 the mail campaign identification number is entered from the envelope and the recipient selects the desired options. At 616 the recipient registers by means of the widget the recipient wishes on future mailings with the data center 10. Where the presentation media is on the smart phone, the recipient runs the mailing widget at block 618 on the smart phone and images the mailing code identification with the phone camera at block 620. At block 622 the widget registers with the data center 10 the mail recipient's wishes, that is, the mail recipient selected options for future mailings. The process then is completed at 608.

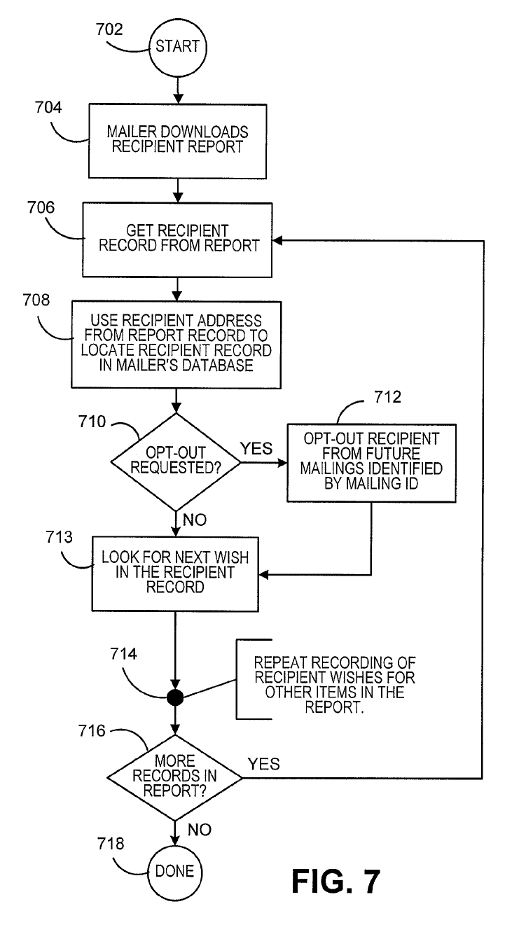

Reference is now made to FIG. 7 which is a flow chart of how the mailer manages recipient wishes. The process starts at 702. At block 704 the mailer downloads the recipient report from the data center over a communications channel such as the Pitney Bowes Inc. Intellilink™ employed with various commercial Pitney Bowes postage meter systems. At block 706 the recipient record from the report is obtained and at block 708 the mailer uses the recipient address from the report record to locate the recipient's record in the mailer's database. A determination is then made at decision block 710 whether an opt out has been requested for the mailing campaign by the recipient. Where this is the case, at block 712 the opt out from future mailing identified by the recipient for the mailing campaign is implemented. At block 713 the next wish or preference, next mail recipient selected option for the mail campaign, in the recipient record is looked at based on the widget information. The repeated recording of recipient wishes for other items in the report continues as denoted at 714. At decision block 716, a determination is made if there are more records in the report where this is not the case the process is completed at 718. However, where there are more records in the report, the process loops back to block 706 to get the recipient record from the reports.

It should be noted that the process is adapted to provide various functionality for the mailer and the recipient. For example, the widget can have an option to initiate a call back from the mailer or call back from an associated service like a catalog provider. The options can be used to initiate requests for additional associated materials or items and other options can be provided to the recipient. These other options as previously noted, for example, can be employed for address correction and can be used to stop duplicate mailings to the recipient. This is particularly important since often duplicate mailings often occur because of multiple spellings or address errors in a mailing list database.

There are many types of mailing campaigns. However, all mailing campaigns are an organized mailing program by mailers to make recipients aware of special programs or offers for the purpose of transacting business between the mailer or their customer and the mail recipient and may include multiple programs and offers. The mail campaign request form can be in any format and communicated in any way from the mail preparation center to the data center so long as a campaign identifier is communicated for a particular mailing campaign as well as the various mail recipient mailing campaign options that the recipient might select. While the present invention has been disclosed and described with reference to a single embodiment thereof, it will be apparent, as noted above that variations and modifications may be made therein. It is, thus, intended in the following claims to cover each variation and modification that falls within the true spirit and scope of the present invention.

What is claimed is:

1. A system for identifying recipient mailing preferences to mailers, the system comprising:
a data center having a mailer component in communication with a mailer and a recipient component in communication with a network accessible by recipients, the mailer component configured to provide mail campaign identifiers to the mailer, the recipient component includes a recipient registration facility, whereby recipients provide information identifying themselves and an interface is provided for allowing recipients to input mail campaign identifiers that they have received and for expressing preferences for receiving mail;
a printer used for preparing the mailer's mail, the printer in communication with the data center and receiving mail campaign identifier's from the data center to be printed on the mailer's mail;
wherein the data center receives a communication from a recipient indicating that the recipient has received mail with the printed mail campaign identifier, and whereby the data center receives recipient mailing preferences in connection with that received mail campaign, and wherein the data center is further configured to store the recipient preferences and to communicate those preferences to the mailer.

2. The system of claim 1 wherein the printer is a postage meter that prints postage indicia and the campaign identifiers, and whereby a communication port of the postage meter can be used to receive postage funds and campaign identifiers.

3. The system of claim 1 wherein the mailer component of the data center is further configured to receive a listing of recipient options with respect to mailing campaigns from the mailer, and whereby the recipient component of the data center is configured to present the recipient options to the recipient upon identification of the corresponding mailing campaign identifier by the recipient.

4. A method for identifying recipient mailing preferences to mailers, comprising the steps of:
communicating from a mail preparation center to a data center mail recipient options with respect to a mail campaign;
receiving mail campaign identifiers from the data center;
said mail preparation center printing and sending mail pieces to a plurality of mail recipients included in said mail campaign, each of said mail pieces having a mail campaign identifier printed thereon that can be communicated back to the data center;
receiving recipient preference information collected by the data center received from mail recipients in connection with the mail campaign identifier, said recipient preferences having been selected from recipient options that were provided to the data center from the mail preparation center.

5. The method of claim 4 wherein the mail preparation center further implements the mail recipient preferences received from the data center.

6. The method of claim 4 wherein said mail preparation center includes a postage meter with at least one accounting register for accounting for value comprising the further steps of processing said plurality of mail pieces with said postage meter to account in said accounting register for the value of said mail piece mail campaign identifier of each mail piece processed by said postage meter.

7. The method of claim 6 wherein said postage meter includes a printer and comprising the further step of said postage meter printing with said printer said mail campaign identifier on each of said plurality of mail pieces.

8. The method of claim 6 wherein said postage meter includes a scanner and comprising the further step of said postage meter scanning each of said mail pieces processed by said postage meter to detect mail pieces having said mail campaign identifier such that said postage meter accounts in said accounting register for the value of said mail piece identifier of each mail piece processed by said postage meter.

9. A method for identifying recipient mailing preferences to mailers, comprising the steps of:
communicating from a mail preparation center to a data center a mail campaign mail recipient options with respect to said mail campaign;
said mail preparation center sending mail pieces a plurality of mail recipients included in said mail campaign, each of said mail pieces having a mail campaign identifier printed thereon;
at least one of said plurality of mail recipients populating a widget on a mail recipient processing device with a received mail piece mail campaign identifier to communicate to said data center with said received mail piece campaign identifier;
said data center populating said mail recipient processing device widget with said mail campaign mail recipient campaign options to communicate to said mail piece recipient said mail campaign recipient options; and
said mail recipient populating said mail recipient processing device widget with said mail recipient selected options to communicate to said data center said mail recipient selected options.

10. A method for recipients of mail to inform mailers of mailing preferences as defined in claim 9 wherein said processing device is a computer.

11. A method for recipients of mail to inform mailers of mailing preferences as defined in claim 10 wherein said processing device is a smart phone.

12. A method for recipients of mail to inform mailers of mailing preferences as defined in claim 10 wherein said computer has a camera and comprising the further step of populating said processing device widget with said mail campaign identifier printed on said mail piece by imaging said mail campaign identifier with said computer camera.

13. A method for recipients of mail to inform mailers of mailing preferences as defined in claim 11 wherein said smart phone has a camera and comprising the further step of populating said processing device widget with said mail campaign identifier printed on said by imaging said mail campaign identifier with said smart phone camera.

14. A method for recipients of mail to inform mailers of mailing preferences as defined in claim 9 comprising the further step of said data center communicating said mail recipient selected options communicated by said mail recipient to said data center to said mail preparation center.

15. A method for recipients of mail to inform mailers of mailing preferences as defined in claim 14 comprising the further step of said mail preparation center implementing said mail recipient selected options.

16. A method for recipients of mail to inform mailers of mailing preferences as defined in claim 9 wherein said mail preparation center includes a postage meter with at least one accounting register for accounting for value comprising the further steps of processing said plurality of mail pieces with said postage meter to account in said accounting register for the value of said mail piece mail campaign identifier of each mail piece processed by said postage meter.

17. A method for recipients of mail to inform mailers of mailing preferences as defined in claim 16 wherein said postage meter includes a printer and comprising the further step of said postage meter printing with said printer said mail campaign identifier on each of said plurality of mail pieces.

18. A method for recipients of mail to inform mailers of mailing preferences as defined in claim 16 wherein said postage meter includes a scanner and comprising the further step of said postage meter scanning each of said mail pieces processed by said postage meter to detect mail pieces having said mail campaign identifier such that said postage meter accounts in said accounting register for the value of said mail piece identifier for each mail piece processed by said postage meter.

19. A method for recipients of mail to inform mailers of mailing preferences as defined in claim 9 wherein said selected options include the option for the mail preparation center to contact said mail piece recipient.
